(19) United States
(12) Patent Application Publication
(10) Pub. No.: US 2018/0345441 A1
(43) Pub. Date: Dec. 6, 2018

(54) POWER TOOL EXTENSION HANDLE APPARATUS AND METHOD OF USE

(71) Applicant: Uber Nikeo, LLC, Lake Forest, CA (US)

(72) Inventors: Brian Paul Nix, Laguna Niguel, CA (US); William Paul Seidel, San Clemente, CA (US)

(73) Assignee: Uber Nikeo, LLC, Lake Forest, CA (US)

(21) Appl. No.: 15/609,816

(22) Filed: May 31, 2017

(51) Int. Cl. B24B 23/00; B25F 5/02; B25H 1/00

(52) U.S. Cl. CPC B24B 23/005; B24B 23/04; B25H 1/0021; B25F 5/02

(57) ABSTRACT

A power tool extension handle apparatus for temporarily securing an extension handle on a power tool, the apparatus comprising a clamp assembly comprising a clamp body having a first leg and an offset second leg, the first leg having a first pivot and a first retainer and the second leg having a second retainer, the clamp body further having a handle receiver, and a strap assembly comprising a strap body having a pivot end and an opposite retainer end, the strap assembly further comprising a pivot buckle secured on the pivot end of the strap body and pivotally engaged with the first pivot for selective engagement with the first retainer and a retainer clip at the retainer end of the strap body for selective engagement with the second retainer so as to secure the strap assembly on the clamp assembly and thereby mount the apparatus on the power tool.

### BACKGROUND

The subject of this patent application relates generally to tools, and more particularly to extension handles configured for selectively engaging power tools.

The following description includes information that may be useful in understanding the present invention. It is not an admission that any of the information provided herein is prior art or relevant to the presently claimed invention, or that any publication specifically or implicitly referenced is prior art.

Applicant(s) hereby incorporate herein by reference any and all patents and published patent applications cited or referred to in this application, to the same extent as if each individual publication or patent application were specifically and individually indicated to be incorporated by reference. Where a definition or use of a term in an incorporated reference is inconsistent with or contrary to the definition of that term provided herein, the definition of that term provided herein applies and the definition of that term in the reference does not apply.

By way of background, in interior and exterior construction projects related to both new and renovated residential and commercial buildings it is often the case that power tools must be used on surfaces that are relatively hard to reach. Vertical surfaces such as walls and horizontal overhead surfaces such as ceilings may be beyond the reach of the typical person when standing comfortably on the ground or floor, which of course is generally the safest and most stable position for a worker. Instead, to access an overhead work area, a worker may need to use a ladder, stilts, scaffolding, a scissor lift, or other such equipment that may add cost, inconvenience, and risk to the job. Even low horizontal surfaces such as floors may at times be hard or at least uncomfortable to reach and work on, such as requiring a worker to be on his or her knees or in a stooped posture for extended periods of time. Thus, it is desirable to provide a means by which a power tool such as a palm or orbital sander may be effectively employed in conjunction with a difficult to reach surface while allowing the worker to remain generally upright and standing on the ground or floor.

As proposed in the art, some sander handles are provided to address vibrational concerns. An example is U.S. Pat. No. 6,558,235 to Berg et al., which discloses an ergonomic sander handle for clamping onto a sanding device so that the ergonomic handle can be comfortably gripped by a worker and used to apply the sanding device to a surface. The ergonomic handle includes an elongate body, a clamp head and a bearing. The elongate body is typically a cylindrical aluminum tube with padding for easy and comfortable gripping. One end of the elongate body is attached to the clamp head that attaches to the sanding device. The other end of the elongate body is attached to the bearing which may include a pair of roller balls. To sand a surface, the worker grips the elongate body in a power grip (without significant wrist flexion or deviation) and applies pressure to urge the sanding device and the bearing onto the surface. The power grip minimizes loads on the wrist and hand which reduces the likelihood of musculoskeletal trauma.

A further example of a sander extension handle attachment relates to the ability to adjust the speed control of the sander from the extension handle, as disclosed in U.S. Patent Application Pub. No. US2004/0147209 to Bickford et al., directed to an extension device for palm sanders, consisting of a rigid extension, on which is mounted a housing. The sander fits into a recess in the housing and is held in place by a pair of clamps, mounted on the housing. The housing contains a remotely operated lever, which controls the speed of the sander, by depressing the sander's own speed control. This lever is linked to another lever, which is located at the end of the extension opposite the housing. This configuration then allows the operator to control the sander's function while also extending his reach. The device allows the operator to safely sand large objects or structures that would otherwise require extensive use of ladders and scaffolds, thus preventing undue hazards to the worker. The sander is at any time detachable and requires no alteration in order to attach it to the device.

Still further examples relate to sander extension handles that provide for exhausting dust from the sander through the handle pole itself. U.S. Patent Application Pub. No. US2003/0096565 to Dotta discloses a handle for an orbital sander (10) of the type having a dust extractor (17) containing an exhaust outlet (18), the handle having: a first part in the form of an elongate tubular member (19) having two open ends, one end being attachable to the exhaust outlet (18) to attach the handle to the sander and to allow dust to pass through the first tubular member, the other end being attachable to a dust discharge hose (22), a second part which is extendable over the top of the sander, attachment means (28) to allow the handle (33) to be attached to a pole, and guide means (34) extending from a portion of the handle spaced from the sander, the guide means being adapted to contact the surface to be sanded and functioning to hold the handle (33) relative to the surface such that, when attached to the sander, the sander is in working alignment with the surface. Relatedly, U.S. Patent Application Pub. No. US2006/0073777 to Dotta et al. discloses an assembly attachable to an orbital sander of the type having a dust extractor containing an exhaust outlet, the assembly comprising mounting means to allow an extension pole to be attached to the assembly, the extension pole being substantially hollow and defining an internal exhaust passageway, and a conduit extending from the extension pole and operatively associated with the exhaust outlet of the orbital sander such that exhaust from the orbital sander passes through the conduit and through the internal exhaust passageway in the extension pole.

And a still further example relates to the ability to attach multiple orbital or palm sanders to a single extension handle as disclosed in U.S. Pat. No. 9,333,615 to Johnson, directed to an apparatus for mounting one or two handheld type orbital sanders thereto so as to permit a user to sand a floor surface from a standing position while moving the mounted sander(s) to and fro by way of a broom handle extending from the apparatus. Typically, the apparatus includes one fixed mount and one moveable mount. Each mount is configured to facilitate attachment to an orbital sander. The moveable mount can be placed and secured in one of two positions: a first position that centers a single sander in line with the handle; and a second position wherein the fixed mount is located to one side of the handle and the moveable mount is secured essentially an equal distance on the other side of the handle.

What has been needed and heretofore unavailable is an ergonomic, relatively easy to use and inexpensive, and substantially universal power tool extension handle apparatus configured to accommodate multiple varieties of power tools, and orbital or palm sanders, specifically, in multiple positions relative to the handle and/or multiple angles of the handle relative to the tool.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a power tool extension handle apparatus for selectively engaging and extending the reach of power tools. In at least one embodiment, the apparatus comprises a clamp assembly comprising a clamp body having a first leg and an offset second leg, the first leg having a first pivot and a first retainer and the second leg having a second retainer, the clamp body further having a handle receiver, and a strap assembly comprising a strap body having a pivot end and an opposite retainer end, the strap assembly further comprising a pivot buckle secured on the pivot end of the strap body and pivotally engaged with the first pivot for selective engagement with the first retainer and a retainer clip at the retainer end of the strap body for selective engagement with the second retainer so as to secure the strap assembly on the clamp assembly and thereby mount the apparatus on the power tool.

Other objects, features, and advantages of aspects of the present invention will become more apparent from the following detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary power tool extension handle apparatus, in accordance with at least one embodiment;

FIG. 2 is an exploded perspective view thereof, in accordance with at least one embodiment;

FIG. 3 is a front view thereof, in accordance with at least one embodiment;

FIG. 4 is a back view thereof, in accordance with at least one embodiment;

FIG. 5 is a left side view thereof, in accordance with at least one embodiment;

FIG. 6 is a right side view thereof, in accordance with at least one embodiment;

FIG. 7 is a top view thereof, in accordance with at least one embodiment;

FIG. 8 is a bottom view thereof, in accordance with at least one embodiment;

FIG. 9 is a perspective view thereof as in use with a palm sander and an extension handle, in accordance with at least one embodiment;

FIG. 10 is a reduced scale further perspective view thereof as in use with a palm sander and an extension handle, in accordance with at least one embodiment;

FIG. 11 is a perspective view of an alternative exemplary power tool extension handle apparatus, in accordance with at least one embodiment;

FIG. 12 is a reduced scale perspective view thereof as in use with a palm sander and an extension handle, in accordance with at least one embodiment;

FIG. 13 is a perspective view of a further alternative exemplary power tool extension handle apparatus, in accordance with at least one embodiment;

FIG. 14 is a perspective view of a still further alternative exemplary power tool extension handle apparatus, in accordance with at least one embodiment; and

FIG. 15 is a perspective view thereof as in use with a palm sander, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments. More generally, those skilled in the art will appreciate that the drawings are schematic in nature and are not to be taken literally or to scale in terms of material configurations, sizes, thicknesses, and other attributes of an apparatus according to aspects of the present invention and its components or features unless specifically set forth herein.

### DETAILED DESCRIPTION

The following discussion provides many exemplary embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

While the inventive subject matter is susceptible of various modifications and alternative embodiments, certain illustrated embodiments thereof are shown in the drawings and will be described below in detail. It should be understood, however, that there is no intention to limit the invention to any specific form disclosed, but on the contrary, the inventive subject matter is to cover all modifications, alternative embodiments, and equivalents falling within the scope of the claims.

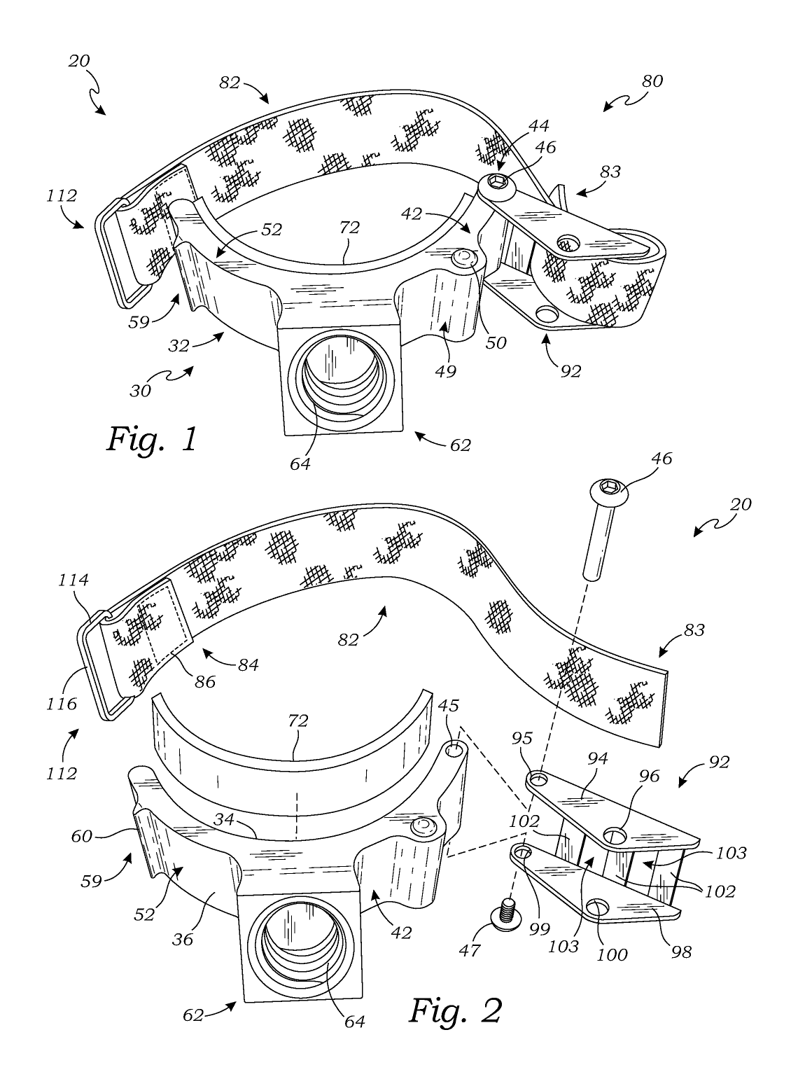

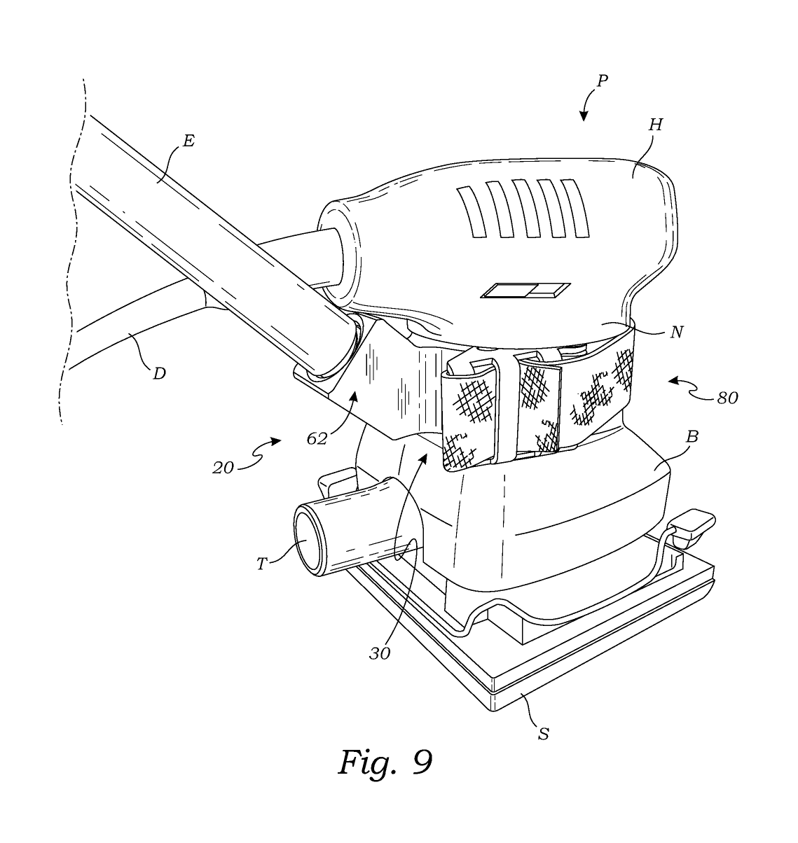

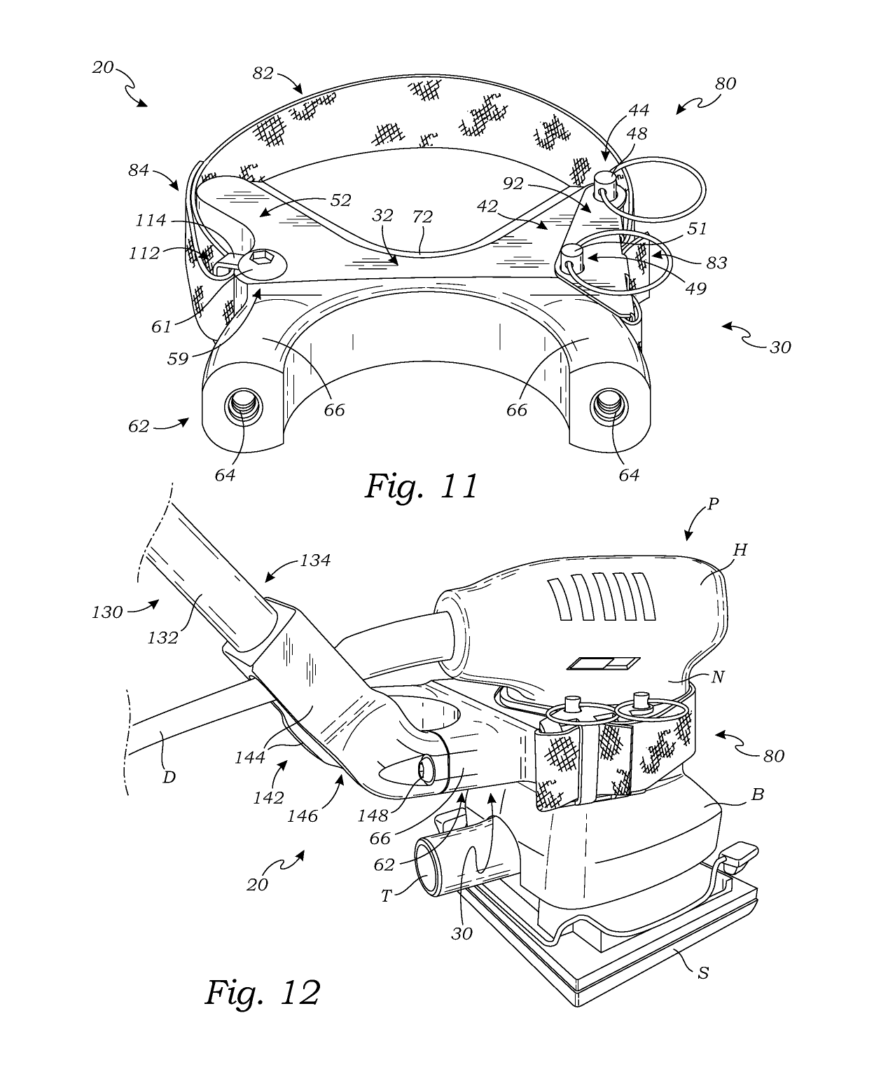

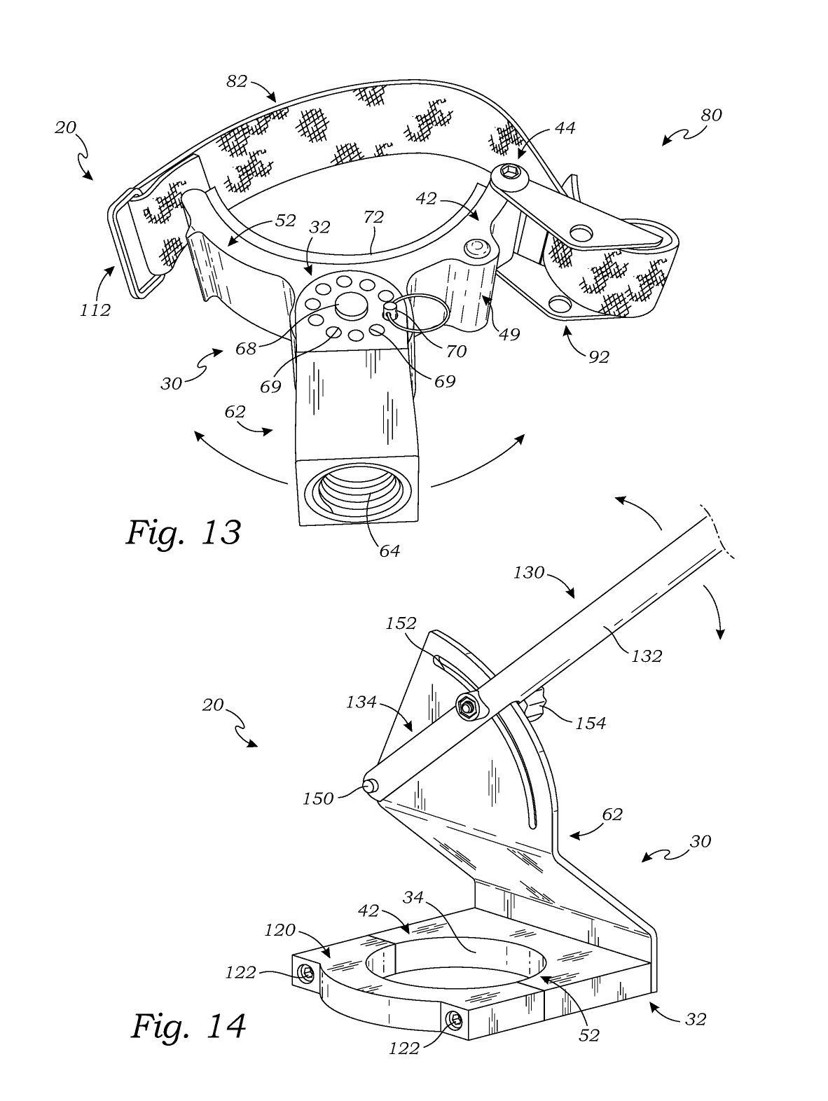

Turning now to FIGS. 1 and 2, there are shown perspective views of an exemplary embodiment of a power tool extension handle apparatus 20 according to aspects of the present invention. The apparatus 20 comprises, in the exemplary embodiment, a clamp assembly 30 configured for engagement about at least a portion of a power tool P (FIG. 9) and for removable acceptance of a broom-style extension handle E (FIG. 9) so as to extend the reach of the power tool P during use. While the exemplary power tool context shown and described is a palm sander, it will be appreciated that other sanders and other power and hand tools more generally may be employed in conjunction with an extension handle apparatus 20 according to aspects of the present invention without departing from its spirit and scope, such that use with a palm sander is to be understood as merely illustrative and non-limiting. The clamp assembly 30 generally comprises a clamp body 32 having offset first and second legs 42, 52 extending therefrom, together defining a relatively curved inner surface 34 here fashioned to substantially conform specifically to the neck N area of the palm sander power tool P (FIG. 9), though again appreciating that other tools and thus other geometries and configurations of the clamp assembly 30 may be employed according to aspects of the present invention. While the legs 42, 52 are shown as being fixed to and integral with the clamp body 32, it will be appreciated that such components may be separately formed and assembled together, for example, as by mounting the legs 42, 52 on the clamp body 32 so as to pivot or articulate relative thereto, thereby further accommodating a range of power tools and sizes. Also here formed integrally with the clamp body 32 is a handle receiver 62 for selective receipt of an extension handle E (FIG. 9). In the first exemplary embodiment, the handle receiver 62 is specifically shown as having formed therein a single, central receiver threaded hole 64 for threadable receipt of a conventional broom handle-style extension handle E, though those skilled in the art will appreciate that other engagement means now known or later developed, including but not limited to press- or interference-fit, locking, snap, clip or clamp, and bayonet-type engagements, may be employed. As will be appreciated with reference to the alternative exemplary embodiment discussed further below in connection with FIGS. 11 and 12, other handle-mounting arrangements now known or later developed are possible, including the incorporation of multiple receiver threaded holes 64 and a custom extension handle 130 and handle mount 142. Moreover, while a conventional broom-style handle E is shown and described here in connection with the exemplary embodiment, it will be appreciated that a wide variety of other handles, now known or later developed, may be employed in connection with any such apparatus 20 and any mounting means, including curved or angled handles and telescoping handles. The handle receiver 62, like the legs 42, 52, though here shown as formed integrally with the clamp body 32, may also be a separate component mounted or engaged with the clamp body 32, as will be appreciated from the further exemplary embodiments shown and described further below in connection with FIGS. 13 and 14.

With continued reference to FIGS. 1 and 2, in the exemplary embodiment, a strap assembly 80 is provided to secure the clamp assembly 30 on the power tool P, generally comprising a strap body 82 having a pivot end 83 and an opposite retainer end 84, with a pivot buckle 92 removably and slidably engaged on the strap body 82 substantially at the pivot end 83. The pivot buckle 92 is here shown as comprising opposite or offset first and second buckle walls 94, 98 interconnected by one or more buckle slats 102. In the exemplary embodiment, the pivot buckle 92 has three buckle slats 102 and thus has two gaps or buckle slots 103 therebetween. Those skilled in the art will thus appreciate that in securing the strap body 82 within the pivot buckle 92 at a desired position, the pivot end 83 of the strap body 82 may be threaded through the pivot buckle 92 as by passing through one buckle slot 103, around one or more buckle slats 102, and back through one or both buckle slots 103. Those skilled in the art will appreciate that the particular configuration of the pivot buckle 92 and the engagement therewith of the strap body 82 is merely illustrative and non-limiting and that a variety of other arrangements now known or later developed may be employed according to aspects of the present invention without departing from its spirit and scope. Relatedly, and with continued reference particularly to the exploded perspective view of FIG. 2, the first and second buckle walls 94, 98 of the pivot buckle 92 may be formed with substantially offset and aligned respective first and second buckle wall pivot holes 95, 99 and respective first and second buckle wall retainer holes 96, 100. The first and second buckle wall pivot holes 95, 99 cooperate with a first pivot 44 formed on the first leg 42 of the clamp body 32 of the clamp assembly 30 to pivotally mount the pivot buckle 92 and thus the strap assembly 80 on the clamp assembly 30. In the exemplary embodiment, a pivot bolt 46 passes through the first buckle wall pivot hole 95, then through a clamp pivot hole 45 formed in the first leg 42 of the clamp body 32, and next through the opposite second buckle wall pivot hole 99 and is there secured through engagement of a screw 47 at its opposite end, thus forming the first pivot 44 and enabling the pivot buckle 92 to pivot thereabout. Once more, it will be appreciated by those skilled in the art that a variety of other assemblies or means for pivotally attaching or forming the pivot buckle 92 or other such structure on the clamp body 32, whether now known or later developed, may be employed according to aspects of the present invention, such that the exemplary embodiment is to be understood as illustrative and non-limiting. Similarly, the first and second buckle wall retainer holes 96, 100 cooperate with a first retainer 49 formed on the first leg 42 of the clamp body 32 of the clamp assembly 30 to selectively secure or retain the pivot buckle 92 substantially adjacent to the clamp body 32 and thus the strap assembly 80 in a relatively shortened or tightened position on the clamp assembly 30. In the exemplary embodiment, the first retainer 49 is defined by at least one spring-bearing 50 formed on the first leg 42 of the clamp body 32 so as to protrude outwardly therefrom for selective engagement with one or more of the first and second buckle wall retainer holes 96, 100. As best seen in FIG. 4, opposing spring-bearings 50 are formed on opposite sides of the clamp body 32 so as to define the first retainer 49 for selective engagement with the respective first and second buckle wall retainer holes 96, 100 of the pivot buckle 92 when it is pivoted inwardly toward the clamp body 32 about the first pivot 44. Again, those skilled in the art will appreciate that a variety of other arrangements for pivoting and securing the pivot buckle 92 of the strap assembly 80 relative to the clamp body 32 of the clamp assembly 30 are possible according to aspects of the present invention without departing from its spirit and scope, as will be further appreciated in connection with the alternative exemplary embodiment of the power tool extension handle apparatus 20 shown in FIGS. 11 and 12 and described further below. It will be appreciated by those skilled in the art that in tightening down the strap assembly 80 relative to the clamp assembly 30 it is necessary for the retainer end 84 of the strap body 82, or the end opposite the pivot end 83 and thus the pivot buckle 92, to be somehow secured on or to the clamp body 32 as well. In the exemplary embodiment, a retainer clip 112 is formed or affixed at the strap retainer end 84 and configured to selectively and removably engage a second retainer 59 formed on the second leg 52 of the clamp body 32. More specifically, the retainer clip 112 is configured as a frame 114 secured on the strap body 82 as by looping its retainer end 84 through and about the frame 114 and securing it back onto itself as through stitching 86, leaving particularly one end or edge in the form of distal retainer member 116 exposed and free to engage the second retainer 59 here formed as an outwardly-protruding retainer flange 60. It will be appreciated that in use the retainer clip 112 may simply be engaged with the second retainer 59 as by clipping the distal retainer member 116 of the retainer clip 112 behind the retainer flange 60, such that as the strap assembly 80 is then tightened as by adjusting the pivot end 83 of the strap body 82 relative to the pivot buckle 92 and then pivoting the pivot buckle 92 about the first pivot 44 and securing it against or adjacent to the first leg 42 of the clamp body 32 through engagement with the first retainer 49, the power tool extension handle apparatus 20 may thus be removably secured about a power tool P (FIG. 9) or the like as by clamping such power tool P between the clamp assembly 30 and the strap assembly 80. It will be appreciated, whether or not the clamp body 32 and the legs 42, 52 thereof are adjustable, that the incorporation of a flexible strap body 82 within an overall strap assembly 80 that is adjustable as to length and tension as herein described yields a substantially universal power tool extension handle apparatus 20 according to aspects of the present invention for accommodation of a variety of power tools and the like. To this end, and by way of illustration and not limitation, the strap body 82 may be formed of any flexible, substantially non-elastic material now known or later developed, including but not limited to nylon, polyester, polypropylene, or any blends thereof. The clamp body 32, pivot buckle 92, and retainer clip 112 may be formed of any suitable material and by any suitable process now known or later developed, including but not limited to metals such as steel, aluminum, alloys, and the like and a variety of plastics such as polypropylene, polystyrene, polyvinyl chloride (“PVC”), acrylonitrile butadiene styrene (“ABS”), polyethylenes such as high density polyethylene (“HDPE”) and low density polyethylene (“LDPE”), polycarbonate, polyurethane, and other such plastics, thermoplastics, thermosetting polymers, and the like, any of which being formed as by machining, molding, casting, extruding, stamping, etc. A clamp pad 72 may be provided on the clamp inner surface 34 as shown to further accommodate some variance in the configuration or surface of the power tool P and provide a bit of cushioning opposite the strap 82; accordingly, such pad 72 may be formed of any resilient material now known or later developed, including but not limited to polyurethane foam, polyethylene foam, expanded polystyrene foam, expanded polypropylene foam, expanded polyethylene foam, silicone rubber, ethylene propylene diene monomer (“EPDM”), fluoroelastomer, and neoprene. Once more, those skilled in the art will appreciate that a variety of configurations, geometries, materials, and methods of construction or assembly, now known or later developed, are possible according to aspects of the present invention without departing from its spirit and scope.

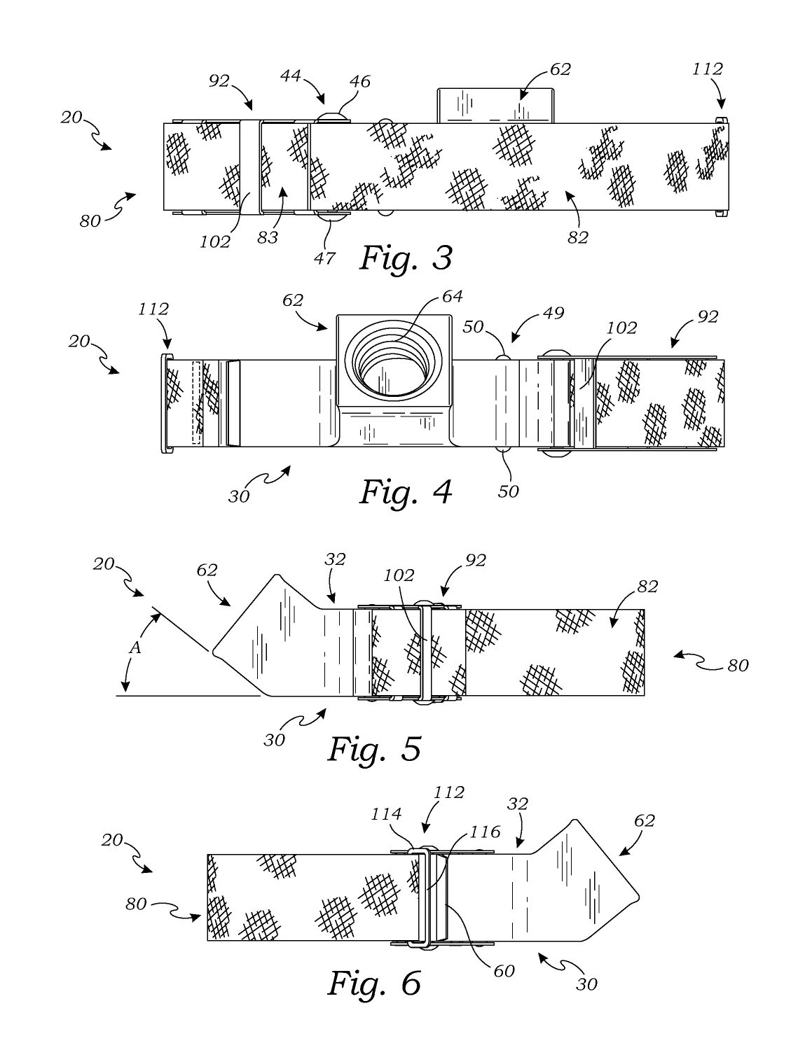

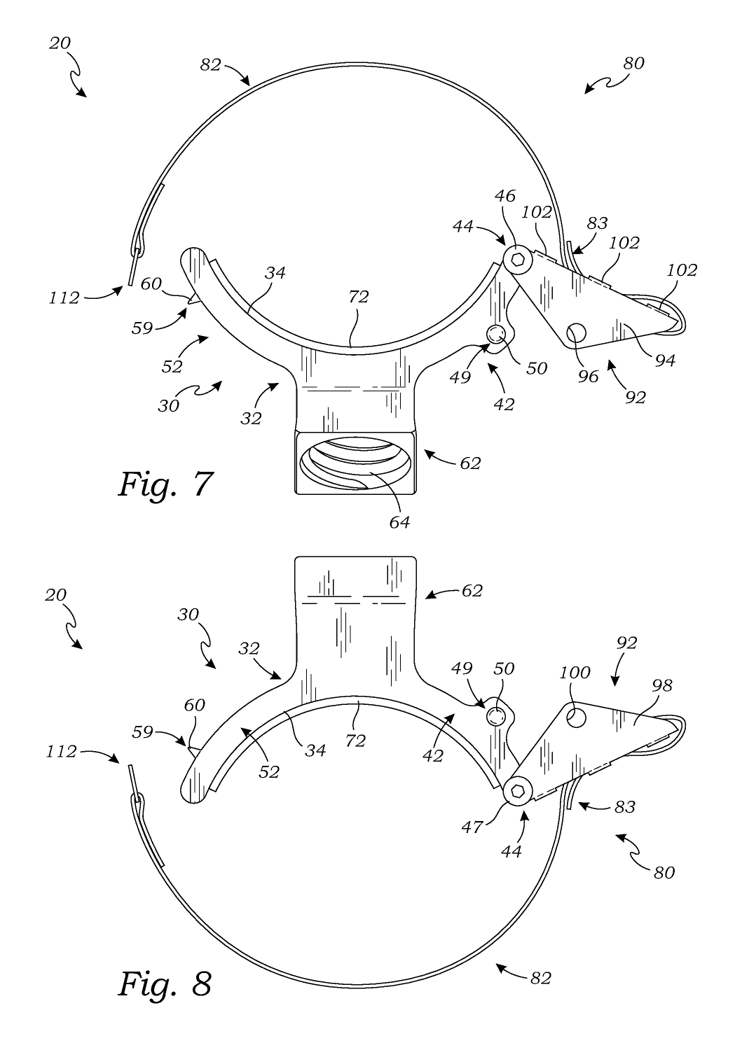

Turning briefly to FIGS. 3-8, there are shown orthogonal views of the exemplary power tool extension handle apparatus 20 of FIGS. 1 and 2. While merely illustrative and non-limiting and again noting that the drawings are schematic in nature and are not to be taken literally or to scale or to represent any exact dimensions, the apparatus 20 being subject to variations in configuration and simple scaling up or down, in the exemplary embodiment the overall dimensions of particularly the strap 82 are approximately three-quarter inch (¾ in.) wide and eight inches (8 in.) long and of the clamp body 32 approximately three inches (3 in.) wide and long and approximately three-quarter inch (¾ in.) deep in the region of the legs 42, 52, though again it will be appreciated that a variety of other dimensions are possible. Even specifically for a palm sander power tool P (FIG. 9) having a neck N with a nominal diameter of two-and-a-half inches (2½ in.), the strap 82 may be in the range of one-half to one inch (½-1 in.) wide and in the range of six to ten inches (6-10 in.) long and the overall dimensions of the clamp body width and/or length may be in the range of two to four inches (2-4 in.). Notably, in the exemplary embodiment as best seen in FIG. 5, the handle receiver 62 may be at an angle A relative to the clamp body 32, here nominally approximately thirty degrees (30°), though again it will be appreciated that for design, ergonomic, or other reasons such angle A of the handle receiver 62 may vary and so may be in the range of fifteen to forty-five degrees (15-45°), for example. The length of the handle receiver 62 may also vary, in part depending on the particular engagement means of the extension handle E therewith, here in the exemplary embodiment again being a threaded hole 64 and so the receiver 62 being of sufficient length for the hole 64 to be of sufficient depth for threaded engagement with a broom handle or the like—typically, such hole 64 or such threaded engagement would be on the order of one inch (1 in.), though again may vary. As best seen in the top and bottom views of FIGS. 7 and 8, the clamp body 32 and associated first and second legs 42, 52 once more together define a curved profile that is to substantially conform to the feature of the power tool P on which the apparatus 20 is to be selectively attached; again, in the exemplary embodiment as shown in FIG. 9, such is the substantially rounded neck N area of the palm sander power tool P. More particularly, taking the nominal diameter of the neck N to be in the range of two to three inches (2-3 in.), it follows that the curvature of the inner surface 34 of the clamp body 32 would have a radius on the order of one to one-and-a-half inches (1-1½ in.). As also can be seen in the top and bottom views of FIGS. 7 and 8, the offset legs 42, 52 defining the perimeter or profile of the clamp body 32 may be of sufficient length to seat against a portion of the power tool neck N but not necessarily even a full half-circle or one hundred eighty degrees (180°) thereabout; in the exemplary embodiment the clamp body 32 may encompass about one hundred thirty-five degrees (135°) of the neck N circumference, with the rest enclosed by the strap 82, though it will be appreciated that the clamp body 32 may generally be configured to circumferentially encompass on the order of one quarter to one half (¼-½) of the feature or to span approximately ninety to one hundred eighty degrees (90-180°) of the overall circumference, with again the remainder being selectively enclosed by operation of the strap assembly 80. Once more, those skilled in the art will appreciate that a variety of configurations and related absolute and proportional sizes for the apparatus 20 and its components such as the clamp assembly 30 and the strap assembly 80 are possible according to aspects of the present invention without departing from its spirit and scope.

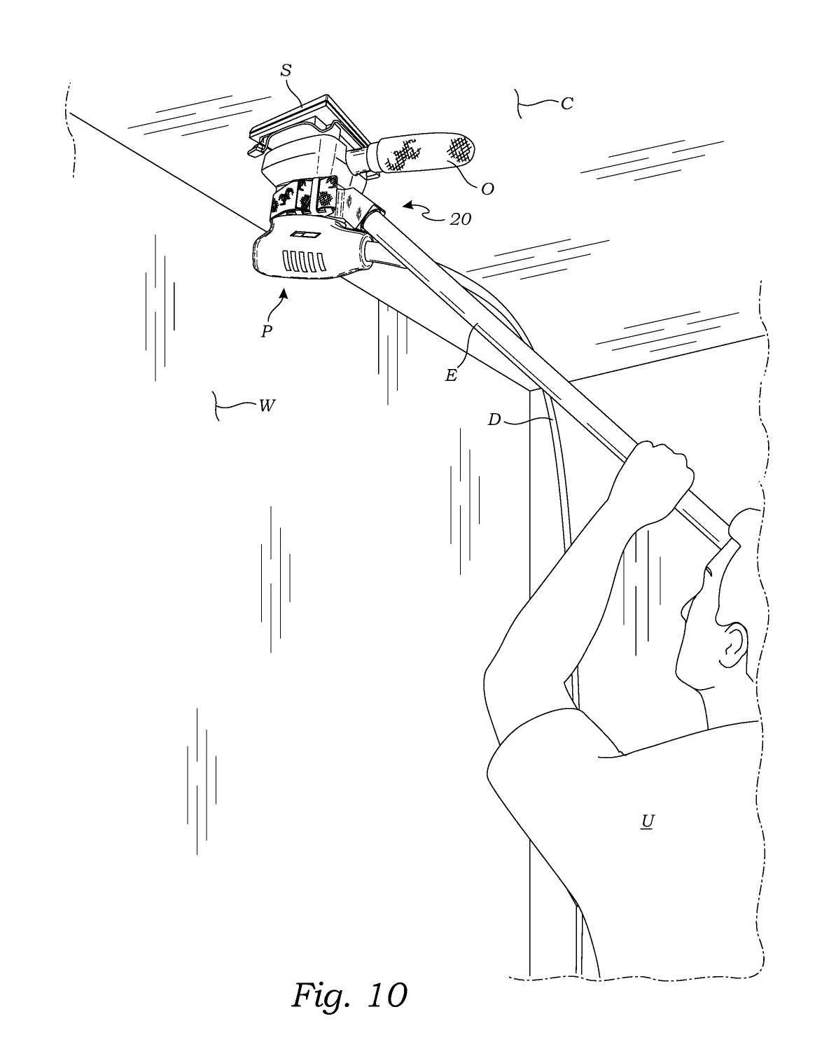

Turning now to FIGS. 9 and 10, the exemplary power tool extension handle apparatus 20 of FIGS. 1-8 is here shown in use as being mounted on a palm sander power tool P and having a broom handle-style extension handle E threadably engaged with the handle receiver 62. As shown, the power tool P generally comprises a head H, an opposite base B, and a relatively smaller or narrower “necked down” portion or neck N intermediate the head H and base B. The clamp assembly 30 and the strap assembly 80 of the apparatus 20 are cooperatively installed about the neck N so as to temporarily secure the apparatus 20 on the power tool P as described above. As shown, the apparatus 20 is installed oriented with the handle receiver 62 angled upwardly relative to the sander power tool P in its normal operational orientation wherein its vibrating or working surface S faces down, against a substantially upwardly-facing, horizontal surface such as a table top or floor or any other board or other item that is oriented horizontally as on a workbench or across saw horses, for example. It will be appreciated that if a floor or other such low horizontal surface were to be sanded, operating the sander power tool P with the apparatus 20 and extension handle E installed as shown in FIG. 9 would enable such floor sanding or the like via the palm sander P as by grasping and manipulating the extension handle E without the user having to be on his or her knees or severely stooped over. It will of course be further appreciated that at times vertical or angled surfaces or even overhead surfaces may require sanding as well. Indeed, as illustrated in FIG. 10, with the exemplary power tool extension handle apparatus 20 installed as oriented in FIG. 9 and then simply inverted or used “upside down,” an overhead surface such as a ceiling C may be relatively easily and safely sanded without the need for ladders, scaffolding, stilts, or the like, depending on the height of the ceiling C and the length of the extension handle E, which may typically be on the order of four to six fee (4-6 ft.) and so would easily allow a user U to sand eight to ten foot (8-10′) high ceilings C, which are most common at least in residential construction, while standing comfortably and safely on the floor. Those skilled in the art will appreciate that walls W all the way up to such a ceiling C may also be easily sanded by grasping and manipulating the extension handle E so as to position the palm sander P as desired with its working surface S against the wall W, ceiling C, or other surface that is to be sanded. Once more, it will be appreciated that the apparatus 20 may be installed on such a palm sander power tool P in any desired orientation, such as being inverted from the position shown in FIG. 9 so as to have the handle receiver 62 oriented downwardly, as might be desirable if an overhead upwardly-facing surface is to be sanded versus an overhead downwardly-facing surface like a ceiling C. It will also be appreciated that the apparatus 20 in any orientation may also be positioned rotationally at virtually any position about the circumference of the palm sander P as may be desired for its manipulation and use, except that it is desirable with such exemplary power tool extension handle apparatus 20 that the angled handle receiver 62 at least be oriented so that it and any extension handle E installed therein clears the power cord D that typically extends from the sander head H as shown. Relatedly, if the apparatus 20 is installed inverted relative to the palm sander P, it should be oriented such that the receiver 62 and handle E clear the sander exhaust T and any dust collector O installed on the exhaust T. Once again, such a power tool extension handle apparatus 20 according to aspects of the present invention may similarly be installed on a variety of other power tools and the like beyond the illustrated palm sander P, which is to be understood as exemplary and non-limiting. That is, it will be appreciated that by providing a sufficiently long strap 82 (FIGS. 1 and 2) and having its effective or working length be adjustable via at least its slidable engagement with the pivot buckle 92 (FIGS. 1 and 2), a variety of tools P and tool features may be engaged. As such, a power tool extension handle apparatus 20 according to aspects of the present invention is provided as being relatively universal in its ability to selectively and removably mount on not just a variety of palm sanders but a variety of other tools as well.

Referring next to FIGS. 11 and 12, there are shown perspective views of an alternative exemplary embodiment of a power tool extension handle apparatus 20 according to aspects of the present invention, both standing alone (FIG. 11) and again as in use on a palm sander power tool P (FIG. 12). First, with reference to FIG. 11, the alternative apparatus 20 again generally comprises a clamp assembly 30 having a clamp body 32 with opposite first and second legs 42, 52, including a clamp pad 72 on the curved inner surface of the clamp body 32. There is also once more a strap assembly 80 for selective engagement with the clamp assembly 30 for enabling the apparatus 20 to be mounted on a power tool P or the like, though here the strap assembly 80 differs from that of the first exemplary embodiment of FIGS. 1-10 in a few respects. First, regarding the pivot buckle 92, while it may itself be configured substantially as best shown in FIG. 2, here it is pivotally attached and then secured in the tightened position on the first leg 42 of the clamp body 32 employing respective pivot and retainer pins 48, 51. That is, the pivot end of the pivot buckle 92 is pivotally mounted on the first leg 42 by here passing a pivot pin 48 through the first buckle wall pivot hole 95 (FIG. 2), the clamp pivot hole 45 (FIG. 2) formed in the first leg 42, and the second buckle wall pivot hole 99 (FIG. 2) so as to define the first pivot 44. Similarly, once the strap body 82 is adjusted within the pivot buckle 92 and the pivot buckle 92 is pivoted about the first pivot 44, or the pivot pin 48, into the tightened position, the pivot buckle 92 is then secured in place by passing the retainer pin 51 through the first buckle wall retainer hole 96 (FIG. 2), a clamp retainer hole (not shown) formed in the first leg 42 in the location of the former spring-bearings 50 (FIGS. 1 and 4), and the second buckle wall retainer hole 100 (FIG. 2) so as to define the first retainer 49. Opposite the pivot buckle 92, the strap body 82 is again formed about a retainer clip 112 having a frame 114 that here is secured to the clamp body 32 in the vicinity of the second leg 52 by a retainer bolt 61 defining the second retainer 59. Those skilled in the art will appreciate that with the retainer end 84 of the strap body 82 mounted or fixed on the clamp body 32, here, in order to at least partially disengage the strap assembly 80, or an end of the strap body 82, from the clamp assembly 30 so as to mount a power tool P therein, with the pivot buckle 92 not secured but freely pivoting, the pivot pin 48 may be pulled so as to temporarily completely disengage the pivot buckle 92 from the clamp body 32 and thereby allow insertion of a tool P and then reengagement and actuation of the pivot buckle 92 to mount the apparatus 20 on the tool P, assuming the tool P cannot slide between the clamp assembly 30 and the strap assembly 80 while the strap body 82 is secured to the clamp body 32 at both ends. Those skilled in the art will once again appreciate that a variety of such components and any combinations thereof are possible according to aspects of the present invention without departing from its spirit and scope.

With continued reference to FIGS. 11 and 12, it may be further observed that here the handle receiver 62 extending from the clamp body 32 is formed having offset receiver legs 66 in the end of each of which is formed a receiver threaded hole 64, thus having two such offset, spaced-apart holes 64 rather than one central receiver threaded hole 64 (FIGS. 1 and 2) as in the first exemplary embodiment. Accordingly, to facilitate mounting an extension handle 130 on such a handle receiver 62, a handle mount 142 may be formed on the distal end 134 of the handle shaft 132. In the alternative exemplary embodiment shown, the handle mount 142 may be formed having offset handle mount legs 144 corresponding to the receiver legs 66 of the handle receiver 62, whereby the handle mount 142 may be mounted on the handle receiver 62 as by handle mount screws 148 passing through openings (not shown) in the handle mount 142 and into the respective receiver threaded holes 64 so as to join the handle mount legs 144 with the respective receiver legs 66 and thus install the extension handle 130 on the apparatus 20. It will be appreciated by those skilled in the art that a virtually infinite variety of configurations of the handle mount 142 and any fasteners for installing the handle mount 142 on the receiver 62 are possible, such that the exemplary arrangement is to be understood as illustrative and non-limiting. Relatedly, as shown in FIG. 12, the handle mount 142 and the handle mount legs 144 particularly may be bent or angled so that the handle mount 142 and associated extension handle 130 extend away from the clamp assembly 30 and clamp body 32 at an angle, here of approximately forty-five degrees (45°), though of course other angles are possible in various configurations and contexts. It will also be appreciated particularly with reference to FIG. 12 illustrating the alternative exemplary power tool extension handle apparatus 20 in use that the gap or space formed between the respective receiver legs 66 and handle mount legs 144 creates a handle mount opening 146 through which, for example, the power cord D of the palm sander power tool P may pass when the apparatus is installed, the opening 146 serving to allow substantially central installation of the apparatus 20 on the power tool P with the extension handle 130 essentially being in the same plane as the power cord D and the exhaust T, though again other orientations of the apparatus 20 relative to the tool P are possible. When the cord D extends through the opening 146 it will be appreciated that the structure surrounding the cord D will thus protect it and prevent it from being kinked or bending back toward the sander P when in use. Similarly, if the apparatus 20 is installed inverted and is to be oriented somewhat centrally, the same handle mount opening 146 would then provide clearance for any dust collector O (FIG. 10) installed on the sander exhaust T. Once so assembled, the palm sander power tool P with power tool extension handle apparatus 20 and related extension handle 130 mounted thereon as through the handle mount 142 may be employed in sanding any desired surface as described herein. Here, it will be appreciated that the extension handle 130 and particularly the handle shaft 132 may be formed integrally with the handle mount 142 or the two components may again be removably engaged employing any means now known or later developed.

Referring briefly to FIG. 13, there is shown a perspective view of a further alternative exemplary embodiment power tool extension handle apparatus 20 according to aspects of the present invention. Here, the apparatus 20 is essentially identical to the first exemplary embodiment of FIGS. 1-10, except that the handle receiver 62 is pivotable relative to the clamp assembly 30. Particularly, the handle receiver 62 is formed as a separate component and pivotally installed on the clamp body 32 as through a receiver pivot 68. Here, the receiver pivot 68 is oriented so as to allow the handle receiver 62 to pivot somewhat left and right relative to the clamp body 32 which would enable the direction of operation or force relative to the power tool P (FIGS. 9, 10 and 12) to be adjusted without adjusting or having to loosen and tighten the engagement of the apparatus 20 with the tool P, which it will be appreciated may be convenient during certain uses, such as working in corners. It will also be appreciated though not shown that instead or in addition, the receiver pivot 68 may be arranged to allow the handle receiver 62 to pivot somewhat up and down relative to the clamp body 32 so as to thereby enable the direction or angle of the extension handle 130 relative to the power tool P to be adjusted, which again may be convenient when working on multiple surfaces, such as transitioning from sanding a ceiling C to an adjoining wall W (FIG. 10), or vice versa. Those skilled in the art will appreciate that a variety of such pivots and their arrangement are possible according to aspects of the present invention, such that that shown and described is to be understood as merely illustrative and non-limiting. With continued reference to FIG. 13, the particular side-to-side pivot arrangement shown, and again any other such arrangement for up-down pivoting or otherwise, may comprise an array of receiver pivot holes 69 formed in the articulating handle receiver 62 about the central receiver pivot 68 for selective indexing of the pivot or angular position as by inserting a receiver pivot pin 70 through a select receiver pivot hole 69 and into the clamp body 32, or more particularly inserting the receiver pivot pin 70 through a receiver pivot hole 69 aligned with a hole (not shown) in the clamp body 32 when the handle receiver 62 is shifted or indexed to the desired position so as to align such holes for the passage therethrough of the receiver pivot pin 70 and thereby lock the handle receiver 62 in a desired position relative to the clamp body 32.

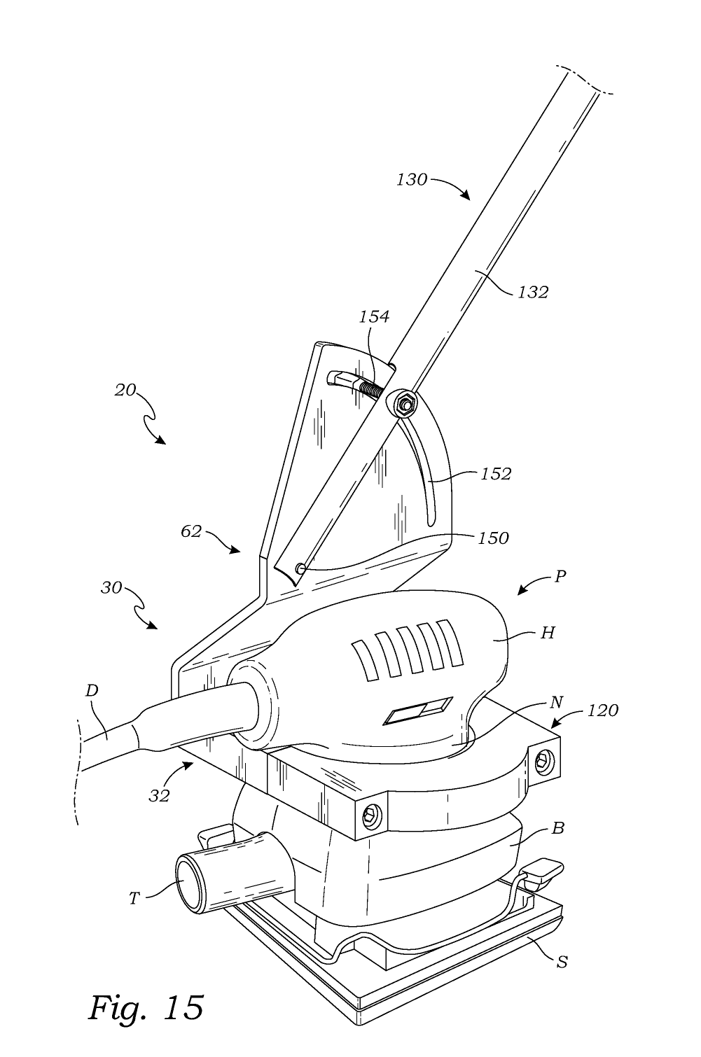

Turning finally to FIGS. 14 and 15, there are shown perspective views of a still further alternative exemplary embodiment of a power tool extension handle apparatus 20 according to aspects of the present invention, both standing alone (FIG. 14) and again as in use on a palm sander power tool P (FIG. 15). First, with reference to FIG. 14, the alternative apparatus 20 again generally comprises a clamp assembly 30 having a clamp body 32 with opposite first and second legs 42, 52 and a handle receiver 62 installed on the clamp body 32. Here, the handle receiver 62 is formed as an angled plate essentially mounted on the back or edge of the clamp body 32 opposite of the legs 42, 52 and then formed to bend or extend back over the clamp body 32, and particularly the legs 42, 52 and related inner surface 34 so as to thus position any extension handle 130 mounted on the handle receiver 62 substantially over or aligned with the midline of any power tool P mounted within the apparatus 20. To install any such tool P, rather than a strap assembly 80 as in prior embodiments, though such or any other removable engagement means now known or later developed may be employed, here there is shown a clamp bracket 120 configured to engage the offset legs 42, 52 of the clamp body 32 and thus complete the clamp assembly 30 and provide for complete securement about the perimeter or circumference of any power tool P feature on which the apparatus 20 is to be selectively mounted. As shown, a pair of clamp bracket screws 122 may be provided for the purpose of mounting the clamp bracket 120 onto the clamp body 32. As for the handle receiver 62, here the angled plate defining the receiver 62 is formed opposite the clamp body 32, in the region thereover, having a handle mount pin 150 on which the handle shaft 132 of the extension handle 130 is pivotally engaged at a distal end 134 thereof. A handle mount bolt 154 engages the handle shaft 132 offset from the handle mount pin 150 through a handle mount slot 152 formed in the receiver 62, whereby the angle of the extension handle 130 relative to the handle receiver 62 and thus the clamp assembly 30 may be adjusted by selectively loosening the handle mount bolt 154, pivoting the handle shaft 132 about the handle mount pin 150 as the handle mount bolt 154 slides within the handle mount slot 152, and retightening the handle mount bolt 154 to secure the extension handle shaft 132 relative to the clamp assembly 30 in the desired position. It will be appreciated by those skilled in the art that such further alternative exemplary apparatus 20 thus enables articulation or selective adjustment of the angle of the extension handle 130 relative to the power tool P installed within the apparatus 20. In addition, once more, as in other embodiments, the power tool P may be installed in various orientations relative to the apparatus 20, with the angled arrangement of the handle receiver plate 62 providing clearance such as over or around the head H of the typical palm sander power tool P even as the neck N is secured within the clamp assembly 30 as by being clamped between the clamp body 32 and the clamp bracket 120. Once more, those skilled in the art will appreciate that a variety of other arrangements and combinations and configurations of components are possible according to aspects of the present invention without departing from its spirit and scope. By way of further illustration and not limitation, the clamp assembly 30 and clamp body 32 particularly may be configured as in the other exemplary embodiments shown and described in connection with FIGS. 1-13 and so interface with a strap assembly 80 for the purpose of mounting the power tool P therein while having an angled handle receiver 62 and pivotally adjustable extension handle 130 engaged therewith as in the embodiment of FIGS. 14 and 15.

Aspects of the present specification may also be described as follows:

1. A power tool extension handle apparatus for temporarily securing an extension handle on a power tool having a neck, the apparatus comprising: a clamp assembly comprising a clamp body having a first leg and an offset second leg, the first leg having a first pivot and a first retainer and the second leg having a second retainer, the clamp body further having a handle receiver with a receiver threaded hole formed therein, the clamp body and the first and second legs together defining a curved clamp inner surface; and a strap assembly comprising a strap body having a pivot end and an opposite retainer end, the strap assembly further comprising a pivot buckle having a first buckle wall and an opposite second buckle wall interconnected by spaced-apart buckle slats so as to form buckle slots therebetween, the strap body being selectively passed around the buckle slats and through the buckle slots so as secure the pivot end of the strap body within the pivot buckle, the first and second buckle walls being formed with respective and opposite first and second buckle wall pivot holes such that the pivot buckle is pivotally engaged with the first pivot formed on the first leg of the clamp body, the strap body being further formed having a retainer clip at the retainer end of the strap body for selective engagement with the second retainer formed on the second leg of the clamp body; whereby the clamp assembly and the strap assembly may cooperatively engage the neck of the power tool as by the clamp body being positioned such that the curved clamp inner surface partially encompasses the neck of the power tool and then securing the strap assembly on the clamp assembly so as to fully encompass the neck as by adjusting the pivot end of the strap body within the pivot buckle, engaging the retainer clip at the retainer end of the strap body with the second retainer formed on the second leg of the clamp body, and pivoting the pivot buckle about the first pivot so as to engage the pivot buckle with the first retainer formed on the first leg of the clamp body so as to temporarily secure the apparatus about the power tool, enabling increased reach with the power tool through engagement of the extension handle with the handle receiver formed on the clamp body.

2. The apparatus of embodiment 1 wherein: the clamp body is further formed having a clamp outer surface offset from the clamp inner surface; and the handle receiver is formed so as to extend from the outer surface.

3. The apparatus of embodiment 1 or embodiment 2 wherein the handle receiver is at an angle of fifteen to forty-five degrees relative to the clamp body.

4. The apparatus of any of embodiments 1-3 wherein the handle receiver is pivotable relative to the clamp body.

5. The apparatus of any of embodiments 1-4 wherein the handle receiver comprises: a receiver pivot pivotally engaging the clamp body intermediate the first and second legs; an array of receiver pivot holes formed offset from the receiver pivot; and a receiver pivot pin engaging both a select pivot hole of the handle receiver and the clamp body so as to selectively and temporarily fix the handle receiver relative to the clamp body.

6. The apparatus of any of embodiments 1-5 wherein: the handle receiver is further formed having a handle mount pin offset from an arcuate handle mount slot formed therein; and the extension handle is formed having a handle shaft configured at a distal end thereof to pivotally engage the handle receiver as by being pivotally connected to the handle mount pin and having a handle mount bolt that engages the handle shaft offset from the handle mount pin through the handle mount slot.

7. The apparatus of any of embodiments 1-6 further comprising a clamp pad formed on the clamp inner surface.

8. The apparatus of any of embodiments 1-7 wherein the first and second buckle wall pivot holes are substantially aligned.

9. The apparatus of any of embodiments 1-8 wherein a pivot bolt passes through the respective first and second buckle wall pivot holes and an intermediate clamp pivot hole formed in the first leg of the clamp body, the pivot bolt and clamp pivot hole together defining the first pivot and thereby pivotally engaging the pivot buckle with the first leg of the clamp body.

10. The apparatus of embodiment 9 wherein a screw is engaged axially with the pivot bolt to secure the pivot bolt within the clamp pivot hole.

11. The apparatus of any of embodiments 1-8 wherein a pivot pin passes through the respective first and second buckle wall pivot holes and an intermediate pivot hole formed in the first leg of the clamp body, the pivot pin and clamp pivot hole together defining the first pivot and thereby pivotally engaging the pivot buckle with the first leg of the clamp body.

12. The apparatus of any of embodiments 1-11 wherein a first spring-bearing defining the first retainer is formed on the first leg of the clamp body offset from the first pivot so as to selectively engage a first buckle wall retainer hole formed in the first buckle wall offset from the first buckle wall pivot hole as the pivot buckle is pivoted about the first pivot and thereby temporarily secure the pivot buckle adjacent to the first leg of the clamp body.

13. The apparatus of embodiment 12 wherein a second spring-bearing further defining the first retainer is formed on the first leg of the clamp body offset from the first pivot so as to selectively engage a second buckle wall retainer hole formed in the second buckle wall offset from the second buckle wall pivot hole.

14. The apparatus of any of embodiments 1-11 wherein a retainer pin defining the first retainer is configured to selectively pass through a first buckle wall retainer hole formed in the first buckle wall offset from the first buckle wall pivot hole and pass into the first leg of the clamp body offset from the first pivot as the pivot buckle is pivoted about the first pivot and thereby temporarily secure the pivot buckle adjacent to the first leg of the clamp body.

15. The apparatus of embodiment 14 wherein the retainer pin defining the first retainer is configured to selectively further pass through the first leg of the clamp body offset from the first pivot and through a second buckle wall retainer hole formed in the second buckle wall offset from the second buckle wall pivot hole.

16. The apparatus of any of embodiments 1-15 wherein a first buckle wall retainer hole formed in the first buckle wall offset from the first buckle wall pivot hole and a second buckle wall retainer hole formed in the second buckle wall offset from the second buckle wall pivot hole are substantially aligned.

17. The apparatus of any of embodiments 1-16 wherein a substantially-outwardly projecting retainer flange defining the second retainer is formed on the second leg of the clamp body so as to selectively engage the retainer clip formed on the retainer end of the strap body of the strap assembly.

18. The apparatus of any of embodiments 1-17 wherein the retainer clip comprises a frame having a distal retainer member configured to selectively engage the retainer flange.

19. The apparatus of any of embodiments 1-16 wherein a retainer bolt defining the second retainer is configured to selectively engage the retainer clip formed on the retainer end of the strap body of the strap assembly with the second leg of the clamp body.

20. The apparatus of any of embodiments 1-19 wherein the retainer clip comprises a frame that is at least partially retained on the retainer end of the strap body of the strap assembly as by looping the strap body over the frame and securing as through stitching.

21. The apparatus of any of embodiments 1-20 wherein the extension handle comprises a handle shaft having an integral handle mount at a distal end thereof configured for removable engagement with the receiver threaded hole as by a handle mount screw.

22. The apparatus of embodiment 21 wherein: the handle receiver further comprises offset receiver legs, each receiver leg having a receiver threaded hole; and the handle mount is formed having offset handle mount legs substantially corresponding to the offset receiver legs, the offset handle mount legs defining a handle mount opening therebetween.

23. The apparatus of any of embodiments 1-22 wherein the first and second legs of the clamp body are diverging.

24. The apparatus of any of embodiments 1-22 wherein the first and second legs of the clamp body are substantially parallel.

25. The apparatus of any of embodiments 1-24 wherein the clamp body is aluminum.

26. The apparatus of any of embodiments 1-25 wherein the strap body is nylon.

27. The apparatus of any of embodiments 1-26 wherein the pivot buckle is mild steel.

28. The apparatus of any of embodiments 1-27 wherein the extension handle is threaded.

29. The apparatus of any of embodiments 1-28 wherein the extension handle is telescoping.

30. The apparatus of any of embodiments 1-29 wherein the extension handle is curved.

31. The apparatus of any of embodiments 1-30 wherein the extension handle is angled.

32. A method of employing a power tool extension handle apparatus as defined in any one of embodiments 1-31, the method comprising the steps of: positioning the clamp body such that the curved clamp inner surface partially encompasses the neck of the power tool; and securing the strap assembly on the clamp assembly so as to fully encompass the neck, comprising the further steps of: adjusting the pivot end of the strap body within the pivot buckle; engaging the retainer clip at the retainer end of the strap body with the second retainer formed on the second leg of the clamp body; and pivoting the pivot buckle about the first pivot so as to engage the pivot buckle with the first retainer formed on the first leg of the clamp body so as to temporarily secure the apparatus about the power tool.

33. The method of embodiment 32 wherein the step of adjusting the pivot end of the strap body within the pivot buckle comprises the further step of selectively passing the strap body around the buckle slats and through the buckle slots so as secure the pivot end of the strap body within the pivot buckle a desired distance from the retainer end of the strap body.

34. The method of embodiment 32 or embodiment 33 wherein the step of engaging the retainer clip at the retainer end of the strap body with the second retainer formed on the second leg of the clamp body comprises the further step of engaging the distal retainer member of the frame of the retainer clamp with the retainer flange formed on the second leg of the clamp body.

35. The method of any of embodiments 32-34 wherein the step of engaging the retainer clip at the retainer end of the strap body with the second retainer formed on the second leg of the clamp body comprises the further step of engaging the retainer bolt with the retainer clip and with the second leg of the clamp body.

36. The method of any of embodiments 32-35 wherein the step of pivoting the pivot buckle about the first pivot so as to engage the pivot buckle with the first retainer further comprises passing the pivot bolt through the respective first and second buckle wall pivot holes and the intermediate clamp pivot hole formed in the first leg of the clamp body and pivoting the pivot buckle about the pivot bolt.

37. The method of any of embodiments 32-35 wherein the step of pivoting the pivot buckle about the first pivot so as to engage the pivot buckle with the first retainer further comprises passing the pivot pin through at least the first buckle wall pivot hole and into the clamp pivot hole formed in the first leg of the clamp body and pivoting the pivot buckle about the pivot pin.

38. The method of any of embodiments 32-37 wherein the step of pivoting the pivot buckle about the first pivot so as to engage the pivot buckle with the first retainer comprises engaging the spring-bearing formed on the first leg of the clamp body offset from the first pivot with the first buckle wall retainer hole formed in the first buckle wall offset from the first buckle wall pivot hole.

39. The method of any of embodiments 32-37 wherein the step of pivoting the pivot buckle about the first pivot so as to engage the pivot buckle with the first retainer comprises passing a retainer pin through the first buckle wall retainer hole formed in the first buckle wall offset from the first buckle wall pivot hole and into the first leg of the clamp body offset from the first pivot.

40. The method of any of embodiments 32-39 further comprising the step of temporarily engaging the extension handle with the handle receiver configured on the clamp body.

41. The method of embodiment 40 wherein the step of temporarily engaging the extension handle with the handle receiver comprises screwing the handle shaft into the receiver threaded hole.

42. The method of embodiment 40 wherein the step of temporarily engaging the extension handle with the handle receiver comprises removably engaging the handle mount formed integrally at the distal end of the handle shaft with the receiver threaded hole as by at least one handle mount screw.

43. The method of any of embodiments 40-42 further comprising the step of pivoting the extension handle relative to the handle receiver.

44. The method of embodiment 43 wherein the step of pivoting the extension handle relative to the handle receiver comprises the further steps of: forming the handle mount pin offset from the arcuate handle mount slot formed in the handle receiver; pivotally connecting the distal end of the handle shaft of the extension handle with the handle mount pin; and inserting a handle mount bolt through the handle mount slot and into the handle shaft offset from the handle mount pin.

45. The method of any of embodiments 40-44 further comprising the step of pivoting the extension handle and the handle receiver relative to the clamp body.

46. The method of embodiment 45 wherein the step of pivoting the extension handle and the handle receiver relative to the clamp body comprises the further steps of: pivotally engaging the receiver pivot with the clamp body intermediate the first and second legs; and engaging the receiver pivot pin both with a select pivot hole of the handle receiver from among the array of pivot holes formed offset from the receiver pivot and with the clamp body so as to selectively and temporarily fix the handle receiver relative to the clamp body.

47. The method of any of embodiments 32-46 further comprising the step of grasping the extension handle so as to extend the reach of and manipulate the power tool.

48. A kit comprising a power tool extension handle apparatus as defined in any one of embodiments 1-31.

49. The kit of embodiment 48 further comprising the extension handle.

50. The kit of embodiment 48 or embodiment 49 further comprising instructional material.

51. The kit of embodiment 50 wherein the instructional material provides instructions on how to perform the method as defined in any one of embodiments 32-47.

52. Use of a power tool extension handle apparatus as defined in any one of embodiments 1-31 to extend the reach of a power tool.

53. The use of embodiment 52, wherein the use comprises a method as defined in any one of embodiments 32-47.

54. A power tool extension handle apparatus for use on a power tool having a neck, the apparatus comprising: a clamp assembly comprising a clamp body having a first leg and an offset second leg, the clamp body further having a handle receiver with a handle mount pin offset from an arcuate handle mount slot formed in the handle receiver, the clamp body and the first and second legs together defining a curved clamp inner surface; a clamp bracket configured to removably engage the first and second legs of the clamp body as through at least one clamp bracket screw; and an extension handle having a handle shaft configured at a distal end thereof to pivotally engage the handle receiver as by being pivotally connected to the handle mount pin and having a handle mount bolt that engages the handle shaft offset from the handle mount pin through the handle mount slot; whereby the clamp assembly and the clamp bracket may cooperatively engage the neck of the power tool as by the clamp body being positioned such that the curved clamp inner surface partially encompasses the neck of the power tool and then securing the clamp bracket on the clamp assembly so as to fully encompass the neck and thereby temporarily secure the apparatus about the power tool, enabling increased reach with the power tool through engagement of the extension handle with the handle receiver formed in the clamp body; and further whereby the angle of the extension handle relative to the handle receiver and thus the clamp assembly may be adjusted by selectively loosening the handle mount bolt, pivoting the handle about the handle mount pin as the handle mount bolt slides within the handle mount slot, and retightening the handle mount bolt to secure the extension handle shaft relative to the clamp assembly in the desired position.

In closing, regarding the exemplary embodiments of the present invention as shown and described herein, it will be appreciated that a power tool extension handle apparatus is disclosed and configured for selectively engaging a variety of power tools so as to extend their reach. Because the principles of the invention may be practiced in a number of configurations beyond those shown and described, it is to be understood that the invention is not in any way limited by the exemplary embodiments, but is able to take numerous forms without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. The recitation of numerical ranges of values herein is merely intended to serve as a shorthand method of referring individually to each separate value falling within the range. Unless otherwise indicated herein, each individual value of a numerical range is incorporated into the specification as if it were individually recited herein. Similarly, all lists of values should be considered as inclusive of intermediate values unless the context indicates the contrary.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the application should be construed as indicating any non-claimed element essential to the practice of the invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A power tool extension handle apparatus for temporarily securing an extension handle on a power tool having a neck, the apparatus comprising:
a clamp assembly comprising a clamp body having a first leg and an offset second leg, the first leg having a first pivot and a first retainer and the second leg having a second retainer, the clamp body further having a handle receiver with a receiver threaded hole formed therein, the clamp body and the first and second legs together defining a curved clamp inner surface; and
a strap assembly comprising a strap body having a pivot end and an opposite retainer end, the strap assembly further comprising a pivot buckle having a first buckle wall and an opposite second buckle wall interconnected by spaced-apart buckle slats so as to form buckle slots therebetween, the strap body being selectively passed around the buckle slats and through the buckle slots so as secure the pivot end of the strap body within the pivot buckle, the first and second buckle walls being formed with respective and opposite first and second buckle wall pivot holes such that the pivot buckle is pivotally engaged with the first pivot formed on the first leg of the clamp body, the strap body being further formed having a retainer clip at the retainer end of the strap body for selective engagement with the second retainer formed on the second leg of the clamp body;
whereby the clamp assembly and the strap assembly may cooperatively engage the neck of the power tool as by the clamp body being positioned such that the curved clamp inner surface partially encompasses the neck of the power tool and then securing the strap assembly on the clamp assembly so as to fully encompass the neck as by adjusting the pivot end of the strap body within the pivot buckle, engaging the retainer clip at the retainer end of the strap body with the second retainer formed on the second leg of the clamp body, and pivoting the pivot buckle about the first pivot so as to engage the pivot buckle with the first retainer formed on the first leg of the clamp body so as to temporarily secure the apparatus about the power tool, enabling increased reach with the power tool through engagement of the extension handle with the handle receiver formed on the clamp body.

2. The apparatus of claim 1 wherein the handle receiver comprises:
a receiver pivot pivotally engaging the clamp body intermediate the first and second legs;
an array of receiver pivot holes formed offset from the receiver pivot; and
a receiver pivot pin engaging both a select pivot hole of the handle receiver and the clamp body so as to selectively and temporarily fix the handle receiver relative to the clamp body.

3. The apparatus of claim 1 wherein:
the handle receiver is further formed having a handle mount pin offset from an arcuate handle mount slot formed therein; and
the extension handle is formed having a handle shaft configured at a distal end thereof to pivotally engage the handle receiver as by being pivotally connected to the handle mount pin and having a handle mount bolt that engages the handle shaft offset from the handle mount pin through the handle mount slot.

4. The apparatus of claim 1 wherein a pivot bolt passes through the respective first and second buckle wall pivot holes and an intermediate clamp pivot hole formed in the first leg of the clamp body, the pivot bolt and clamp pivot hole together defining the first pivot and thereby pivotally engaging the pivot buckle with the first leg of the clamp body.

5. The apparatus of claim 1 wherein a pivot pin passes through the respective first and second buckle wall pivot holes and an intermediate pivot hole formed in the first leg of the clamp body, the pivot pin and clamp pivot hole together defining the first pivot and thereby pivotally engaging the pivot buckle with the first leg of the clamp body.

6. The apparatus of claim 1 wherein a first spring-bearing defining the first retainer is formed on the first leg of the clamp body offset from the first pivot so as to selectively engage a first buckle wall retainer hole formed in the first buckle wall offset from the first buckle wall pivot hole as the pivot buckle is pivoted about the first pivot and thereby temporarily secure the pivot buckle adjacent to the first leg of the clamp body.

7. The apparatus of claim 6 wherein a second spring-bearing further defining the first retainer is formed on the first leg of the clamp body offset from the first pivot so as to selectively engage a second buckle wall retainer hole formed in the second buckle wall offset from the second buckle wall pivot hole.

8. The apparatus of claim 1 wherein a retainer pin defining the first retainer is configured to selectively pass through a first buckle wall retainer hole formed in the first buckle wall offset from the first buckle wall pivot hole and pass into the first leg of the clamp body offset from the first pivot as the pivot buckle is pivoted about the first pivot and thereby temporarily secure the pivot buckle adjacent to the first leg of the clamp body.

9. The apparatus of claim 8 wherein the retainer pin defining the first retainer is configured to selectively further pass through the first leg of the clamp body offset from the first pivot and through a second buckle wall retainer hole formed in the second buckle wall offset from the second buckle wall pivot hole.

10. The apparatus of claim 1 wherein a first buckle wall retainer hole formed in the first buckle wall offset from the first buckle wall pivot hole and a second buckle wall retainer hole formed in the second buckle wall offset from the second buckle wall pivot hole are substantially aligned.

11. The apparatus of claim 1 wherein a substantially-outwardly projecting retainer flange defining the second retainer is formed on the second leg of the clamp body so as to selectively engage the retainer clip formed on the retainer end of the strap body of the strap assembly.

12. The apparatus of claim 11 wherein the retainer clip comprises a frame having a distal retainer member configured to selectively engage the retainer flange.

13. The apparatus of claim 1 wherein a retainer bolt defining the second retainer is configured to selectively engage the retainer clip formed on the retainer end of the strap body of the strap assembly with the second leg of the clamp body.

14. The apparatus of claim 1 wherein the retainer clip comprises a frame that is at least partially retained on the retainer end of the strap body of the strap assembly as by looping the strap body over the frame and securing as through stitching.

15. The apparatus of claim 1 wherein the extension handle comprises a handle shaft having an integral handle mount at a distal end thereof configured for removable engagement with the receiver threaded hole as by a handle mount screw.

16. The apparatus of claim 15 wherein:
the handle receiver further comprises offset receiver legs, each receiver leg having a receiver threaded hole; and
the handle mount is formed having offset handle mount legs substantially corresponding to the offset receiver legs, the offset handle mount legs defining a handle mount opening therebetween.

17. The apparatus of claim 1 wherein the first and second legs of the clamp body are diverging.

18. The apparatus of claim 1 wherein the first and second legs of the clamp body are substantially parallel.

19. A power tool extension handle apparatus for temporarily securing an extension handle on a power tool having a neck, the apparatus comprising:
a clamp assembly comprising a clamp body having a first leg and an offset second leg, the first leg having a first pivot configured as a pivot bolt passing through a clamp pivot hole formed in the first leg of the clamp body and having a first retainer configured as a first spring-bearing formed on the first leg of the clamp body offset from the first pivot, and the second leg having a second retainer configured as a substantially-outwardly projecting retainer flange, the clamp body further having a handle receiver; and
a strap assembly comprising a strap body having a pivot end and an opposite retainer end, the strap assembly further comprising a pivot buckle having a first buckle wall and an opposite second buckle wall interconnected by spaced-apart buckle slats so as to form buckle slots therebetween, the strap body being selectively passed around the buckle slats and through the buckle slots so as secure the pivot end of the strap body within the pivot buckle, the first and second buckle walls being formed with respective and opposite first and second buckle wall pivot holes such that the pivot buckle is pivotally engaged with the first pivot formed on the first leg of the clamp body as by the pivot bolt passing through the respective first and second buckle wall pivot holes and the intermediate clamp pivot hole formed in the first leg of the clamp body and thereby pivotally engaging the pivot buckle with the first leg of the clamp body, the pivot buckle being further formed having a first buckle wall retainer hole formed in the first buckle wall offset from the first buckle wall pivot hole for selectively engaging the first spring-bearing formed on the first leg of the clamp body as the pivot buckle is pivoted about the first pivot and to thereby temporarily secure the pivot buckle adjacent to the first leg of the clamp body, the strap body being further formed having a retainer clip at the retainer end of the strap body comprising a frame having a distal retainer member for selective engagement with the retainer flange defining the second retainer formed on the second leg of the clamp body;
whereby the clamp assembly and the strap assembly may cooperatively engage the neck of the power tool as by the clamp body being positioned so as to partially encompass the neck of the power tool and then securing the strap assembly on the clamp assembly so as to fully encompass the neck as by adjusting the pivot end of the strap body within the pivot buckle, engaging the distal retainer member of the retainer clip formed at the retainer end of the strap body with the retainer flange defining the second retainer formed on the second leg of the clamp body, and pivoting the pivot buckle about the pivot bolt defining the first pivot so as to engage the first buckle wall retainer hole formed in the first buckle wall of the pivot buckle with the first spring-bearing defining the first retainer formed on the first leg of the clamp body offset from the first pivot so as to temporarily secure the apparatus about the power tool, enabling increased reach with the power tool through engagement of the extension handle with the handle receiver formed on the clamp body.

20. A power tool extension handle apparatus for use on a power tool having a neck, the apparatus comprising:
a clamp assembly comprising a clamp body having a first leg and an offset second leg, the clamp body further having a handle receiver with a handle mount pin offset from an arcuate handle mount slot formed in the handle receiver, the clamp body and the first and second legs together defining a curved clamp inner surface;
a clamp bracket configured to removably engage the first and second legs of the clamp body as through at least one clamp bracket screw; and
an extension handle having a handle shaft configured at a distal end thereof to pivotally engage the handle receiver as by being pivotally connected to the handle mount pin and having a handle mount bolt that engages the handle shaft offset from the handle mount pin through the handle mount slot;
whereby the clamp assembly and the clamp bracket may cooperatively engage the neck of the power tool as by the clamp body being positioned such that the curved clamp inner surface partially encompasses the neck of the power tool and then securing the clamp bracket on the clamp assembly so as to fully encompass the neck and thereby temporarily secure the apparatus about the power tool, enabling increased reach with the power tool through engagement of the extension handle with the handle receiver formed in the clamp body; and
further whereby the angle of the extension handle relative to the handle receiver and thus the clamp assembly may be adjusted by selectively loosening the handle mount bolt, pivoting the handle about the handle mount pin as the handle mount bolt slides within the handle mount slot, and retightening the handle mount bolt to secure the extension handle shaft relative to the clamp assembly in the desired position.
